(19) United States
(12) Patent Application Publication
(10) Pub. No.: US 2017/0011412 A1
(43) Pub. Date: Jan. 12, 2017

(54) Method of Selecting Production Content for Entertainment Industry Projects

(71) Applicant: BRK Enterprises Inc., Tomball, TX (US)

(72) Inventors: Barbara A Rogers, Katy, TX (US); Kevin Mark Jones, Tomball, TX (US); Mike Sullivan, Katy, TX (US); Ricky LaMay, Capitan, NM (US)

(73) Assignee: BRK ENTERPRISES INC, Tomball, TX (US)

(21) Appl. No.: 14/792,219

(22) Filed: Jul. 6, 2015

(51) Int. Cl. G06Q 30/02; H04N 21/475

(52) U.S. Cl. CPC G06Q 30/0203; H04N 21/4758

(57) ABSTRACT

A system and method of presenting creative concepts assembled into a project to the general public in an attempt to garner support for entertainment industry products which may results from the project, and continuing to maintain the support of the general public during the lengthy process of transforming the project into an entertainment industry project.

### BACKGROUND OF THE INVENTION

### Cross-Reference to Related Applications

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Movie Studios have traditionally made several movies hoping one will be a “blockbuster” which covers the losses of the others. One solution is to utilize industry experts to attempt to predict success based possible actor success, a director's reputation, and possibly a story line tested in earlier releases, i.e. trilogies or franchise products. While saving set and filming cost, this method still requires costs be expended on pre-production, casting, contract negotiations, etc.

Another method of attempting to predict success is to gather focus groups and hope they are representative of the entire audience, and not just a smaller region or interest group. For this, trailers are assembled during the early editing stages to test a movie's marketability. This determines if the movie will ever make it to theaters, or be released through other channels in an attempt to recover funds already expended. If a movie does poorly with a market, then maybe there is enough footage to cut the movie differently, change the ending, or reassemble the cast to shoot bridge scenes or alternative story paths.

The problem lies in this ‘late in production’ determination of actual marketability, at the point where there is enough material to create trailers. The sets have been built, talent has performed and been paid large portions of their contract fees, film has already been shot and possibly enhanced or edited. The only major expense left with making of the film is final editing, marketing, and distribution.

The same issue exists with other entertainment products. To shoot a pilot of a television series, actors must be signed, sets designed and built, locations scouted, etc. Then, if industry insiders and test audiences react favorably, additional expense goes into creating multiple episodes for a viewing season. This may be wasted expense if the series does not draw the audience expected and loses its time slot.

What is desired is a way to test marketability before even pre-production costs are expended. It is desirable that this test be applicable to the actual audience for entertainment industry products, not just a limited subset or industry insiders who may become detached from the larger population.

### BRIEF DESCRIPTION OF THE DRAWINGS

FIG. 1 is a diagram of a computing system utilizing the Internet in accordance with an exemplary embodiment of the invention.

FIG. 2 illustrates the relationship of user actions of a computing system in accordance with an exemplary embodiment of the invention.

FIG. 3 is a flowchart illustrating exemplary interactions of a voting user in accordance with an exemplary embodiment of the invention.

FIG. 4 is a flowchart illustrating calculation and adjustment of influence of a voting user in accordance with an exemplary embodiment of the invention.

FIG. 5 shows the equation for determining Project Support by considering the influence level of voting users in accordance with an exemplary embodiment of the invention.

FIG. 6 is a flowchart illustrating exemplary interactions of a content creator in accordance with an exemplary embodiment of the invention.

FIG. 7 is a flowchart illustrating exemplary interactions of a production user in accordance with an exemplary embodiment of the invention.

FIG. 8 is a flowchart illustrating exemplary interactions of a talent user in accordance with an exemplary embodiment of the invention.

FIG. 9 illustrates the actions of a project from initial concept to final release and public acceptance in accordance with an exemplary embodiment of the invention.

FIG. 10 is an exemplary home screen layout of a voting user in accordance with an exemplary embodiment of the invention.

FIG. 11 is an exemplary project review screen layout in accordance with an exemplary embodiment of the invention.

FIG. 12 is an exemplary project view screen layout in accordance with an exemplary embodiment of the invention.

FIG. 13 is an exemplary project voting and commenting screen in accordance with an exemplary embodiment of the invention.

FIG. 14 is an exemplary home screen layout of a content creator in accordance with an exemplary embodiment of the invention.

### DETAILED DESCRIPTION OF THE PREFERRED EMBODIMENTS

Described herein is a method and system which tests the potential audience (i.e. the movie going public, or TV watching public) to determine the acceptance or approval (the support), and therefore, the likely success of content for entertainment production in a pre-pre-production time frame. The described system further allows input of content from the general public by allowing anyone to submit creative industry content to the process without draining the limited resources of the industry's script readers, producers, etc. who would normally have to screen such content.

This description focuses on the production of a screenplay for movie theater release. One skilled in the art would appreciate the applicability of the method for television series concepts, teleplays, episode scripts, series bibles, movie and television story concepts, and other entertainment content such as music, video game designs/player characters/game maps. The embodiment described herein is centered on an interactive Internet website as it allows interacting with a large cross section of the population across large geographic areas with minimal interference by administering personnel who may unwittingly influence outcomes. One skilled in the art would appreciate that the teachings would apply equally to other means of interacting with large cross sections of the population such as phone, email, face to face, etc. The system may be accomplished by polling individuals in a theater, shopping mall, amusement park, or other public areas and may be conducted in person, messaging, or via telemarketing. The larger the sample size, the better the predictions. It is important that the survey be a cross section of the general public, and not limited to one geographic area, or to a particular group or class of people.

In the preferred embodiment, an online website interacts with a community consisting of individuals who have one or more of three types of users having the following primary roles and interactions. There are content creators (Writers) who submit creative content to be reviewed and supported. There are general voting users (Voters) who view the submitted content and indicate their support by showing an interest level in the content. There are content consumers (Production) which consist of producers, writers, studios, and other content consumers who express interest in various content, and then use the support (quantified into ratings or rankings) of the content to determine potential value prior to securing the content for production (i.e. pre-pre-production).

Other users include internal users or administrators of the system who have various roles defined further below, and data users which extract information from the system, but do not necessarily access the system in an interactive manner. Administrative users include, but are not limited to the following: writers who produce summaries of large content; legal staff who secure intellectual property protection of the content for the content creators; operators who classify content by genre or other classifications; verifiers who verify credentials of users to ensure proper identification of celebrities, industry well-knowns, and others with reputations to be protected; database administrators maintain the database and extract statistical information therefrom. Other types of users are statisticians, industry marketers, and others from related industries who may utilize the system to extract data for marketing persons, or utilize the opportunities to market to targeted groups with cross promotional items.

Creative content may be a movie concept, a screen play, a series concept, an episode concept or script, music, etc. Therefore, a Writer or content creator can be a screen play writer, concept creator, team of writers, artists, musicians, etc. A Writer registers with the system and undergoes verification of identity and credentialization.

Credentialization helps rate the content of the system based on the reputation of persons associated with a project so voter users are not forced to cull through large amounts of amateur work which is unpolished or improper in format and skill level. Credentialization is utilized to prevent someone from attempting to trade on the reputation of another by impersonation. Credentialization is only used to rate work as a classification for purposes of user sorting. It is not utilized to block or disallow content because “everyone has to start somewhere” and a major premise of the system is to give an opportunity for undiscovered talent to be exposed to an audience.

Once credentialization has been completed, the creator then uploads content to the site. The creator then certifies they are the original creator, or representative of the creator(s) and are in compliance with all requirements to share the materials on the site. Uploaded content is now available to the system for evaluation. The Writer may further request additional industry services such as summary writing, editing/polishing, copyright protection, or guild registration. Additional services are provided on behalf of the content creator making it easier for them to get work into the industry with minimal effort. Once work is ready, it may be submitted to the public for viewing and rating.

Getting work ready may require editing of the original work for grammar, formatting, and/or content. A work may need to be registered or copyrighted. A movie script may need to be summarized. A song may need to be recorded. Graphics may be created to convey the concept, or enhance the presentation. Content must be categorized into a genre and screened for offensive materials, infringements or other legal issues, etc.

Content is then presented to the general audience for rating and support. After exposure to the general audience, the support may be determined which the creator may utilize in determining next options, including but not limited to: withdraw and edit/revise the work; incorporate suggestions garnered from the audience; offer the work for sale to production; or allow additional time to generate support. Once a writer has garnered support from the general audience, he has more credibility and leverage when presenting his material to production. This is the primary purpose of the system, although other purposes/results would be apparent to one skilled in the arts and familiar with the industries affected by the described system.

Content is titled, summarized, classified, and otherwise documented and stored in the databases of the system where is accessible to the rest of the process. If content has remained in the database for a period of time without certain events occurring, then the content may be removed from the system. Removal from the system may be by deleting data, archiving, or otherwise marking the content as inactive. The events triggering removal of content from the system may include, but are not limited to: expiration of time contracted by the content creator; reaching of a certain support level; failure to reach a certain support level; production interest negating need for further support data; negative reception by the general audience, administrative problems with the content.

If a content creator designates that content is to be available for a limited amount of time, then at the expiration of the time frame, the content may be removed from the system, or the content creator may be given the opportunity to evaluate the data and determine if additional time is desired. If a content creator is found to not be the original creator, or the holder of rights, then the administrators may remove the content, this may be in response to a takedown notice from the true owner. Additionally, a content creator may request their data be removed from the system for other reasons, such as interest from a production interest outside of the system.

The general audience primarily consists of the entertainment consuming public. They are also referenced herein as voters or users. The general audience is incentivized to participate in the system by being “in the know” about future projects and by getting input into the entertainment industry. They have the opportunity to consider potential future entertainment industry projects, and to express their interest, or lack thereof, in a project. They can also submit comments or critiques while the project is still in its infancy and those comments or critiques may be considered in the shaping of the final product.

Further incentivizing of voters may be accomplished by using spiffs from industry or memorabilia from movie production which supporters are offered via contest, random drawing, or closed auction. Additionally, supporting projects which eventually prove successful, increase a voter's influence in the system. Voter influence may be viewed as a status symbol in the community and to the industry.

Currently cable/satellite providers classify or sort current entertainment programming by channel, genre, talent, etc. A user can select a listing and view a short summary, cast/talent, graphics, and possibly view a trailer. The user then selects to watch the show or continues to search for content of interest. In this system, the voter is presented a list, or can sort or search for projects in the system in much the same way as current program listings are available on cable/satellite providers, however the system does not show current entertainment programming, but projects that may possibly become entertainment offerings in the future.

As the user selects a project, they are shown summary information such as a short description of the project. They may be shown talent who have endorsed the project or otherwise expressed an interest. They may have graphics, storyboards, or other material on which to further base their interest in the project.

The voter then indicates their interest in seeing the project produced into a final product. The voter then has the option to indicate an interest in following the project, and may comment for other voters in a blog format or as a one time review/comment, or may submit feedback to the writer or leave suggestions/comments for potential production.

In the preferred embodiment, the voter may rank a project by voting according to a scale of 1-10, indicating the likelihood they would support the final product by attending/viewing. For instance, a vote of one may indicate that a person would watch the movie if nothing else was playing, but wouldn't specifically go to the movie. A vote of three may indicate that a person intends to watch the movie in second run, Discount Theater, DVD release, or TV. A vote of five may indicate a person plans to see the movie in the first run theaters. A vote of seven means the person intends to see the movie on opening weekend. A vote of ten means the person plans to see the movie multiple times. One skilled in the art will appreciate that scales may be expanded or contracted, and that there may be more or less distinctive positions within the scale. Further, the values may have different meanings for different projects, or may be adjusted depending on the project's target product type.

A raw score is maintained for voters, and may be utilized for non-industry purposes. However, a weighted score is utilized to better gauge actual support from the general public. Not all viewer opinions are equal. A movie enthusiast's or excessive movie goer's opinion is more valuable than someone who only watches TV, but never attends movies. A voter's raw voting score is weighted by one or more of the following criteria: Base Influence, Genre Influence, or Participation Influence.

Base Influence: the base influence is adjusted by a user's industry activity. As a voter's rankings are proven to be more or less aligned with industry rankings, the voter's opinion may be found to be of a higher or lower significance in ranking of future projects. A voter's Base Influence may be further defined by age, income level, education, or other social characteristics.

Genre Influence: the genre influence is adjusted by a user's industry activity in a particular genre of entertainment. The genre influence compensates for voter's preferences for a particular genre as it distinguishes a user's influence over a specific genre which may vary greatly from their influence for the entire industry. For example, a highly involved video gamer may be a good indicator of general audience interest in action movies, but may be less of an indicator in the potential success of made for television documentaries.

Participation Influence: The participation influence is adjusted by a user's activity in the system. A user who reads summaries and watches trailers or comments on site activity is more aware of the process, and therefore their opinion may be of a different value than someone who is unaware of the process. If the user is an avid rater of many projects, it indicates a higher level of interest and higher investment than other users, and therefore an opinion that may have a different value than that of an occasional or casual user.

Production may identify content based on, among other characteristics, the speed at which support grows, or the amount of support received within a given time frame. Administrators may take content with sufficient support and notify talent and production that the content is being offered for development. If done correctly, multiple production users may be interested and compete to win the rights to the content.

Some users may be talent type. Talent users include actors/actresses, directors, set designers, makeup artists, etc. Talent does not solicit or consume creative content, but endorses the content either publicly or privately. In a public endorsement, an actor may state that they would like to play a particular character in a screen play. A director may state that they will take on a project if support reaches a certain level within a specific time frame. This public endorsement generates interest among the public and increases support of specific content by the talent's fans who are voters.

Private endorsement may be visible to production, but not to voters. Content may become more enticing to production when specific talent has shown interest in a project. However, talent may not wish to publically expose their endorsement, as it can have negative effects on their careers if the content is not supported by the public.

Voters create accounts on the system so their settings and preferences can be preserved and their activities group across multiple sessions. Voters review content and support it by voting and or commenting. In the preferred system there are different levels of voting. In one embodiment, the level of voting may be distinguished by free votes, purchased votes, and premium votes. In this embodiment free votes are given each hour, day, or week, etc. and are limited to a maximum that can be held at a given time. This encourages regular participation but limits the system from becoming overwhelmed by voters less invested in the entertainment industry.

Purchased votes carry a higher weight because, as consumers, investing money in a cause shows a higher commitment to the process or the voter's opinion. Premium votes may be awarded as spiffs for industry activity such as purchase of a movie ticket, answering a survey, or entering a code revealed during a movie, show, commercial, etc. Premium votes show a person is engaged in the industry and therefore may have a higher value opinion on future content.

Voters can then select content based on, for instance, type or genre (i.e. screen plays for comedies). One skilled in the art would appreciate that other selection and sorting criteria can also be employed to limit the amount of content presented to the voter. A voter may see limited information about a particular creative content in the form of a list (a content list). Voters are not shown the support level, ratings, or votes already received to prevent trending or bandwagoning from skewing support. In the preferred embodiment this may include the genre, title, and public endorsements by production or talent.

Once a voter selects a content listing from the content list, the voter is taken to a content specific page which focuses on the single content listing. In the preferred embodiment the content specific page includes a title, any art work associated with a project, a listing of any talent or production users who have publically endorsed the project, and a summary of the project. There may also be links to video, audio, or other media files associated with the project. Once a user has informed themselves about the project by reviewing the information, they may cast votes ranking their support of the project.

A user who has supported a project may then add the project to their personal watch list so they will automatically be notified of updates to the project and its support progress any time they enter the system. Additionally, a user may enter comments regarding the project which may be either public or private. Private comments can be directed to specific people associated with the project like the writer, the theater, the producers, etc.

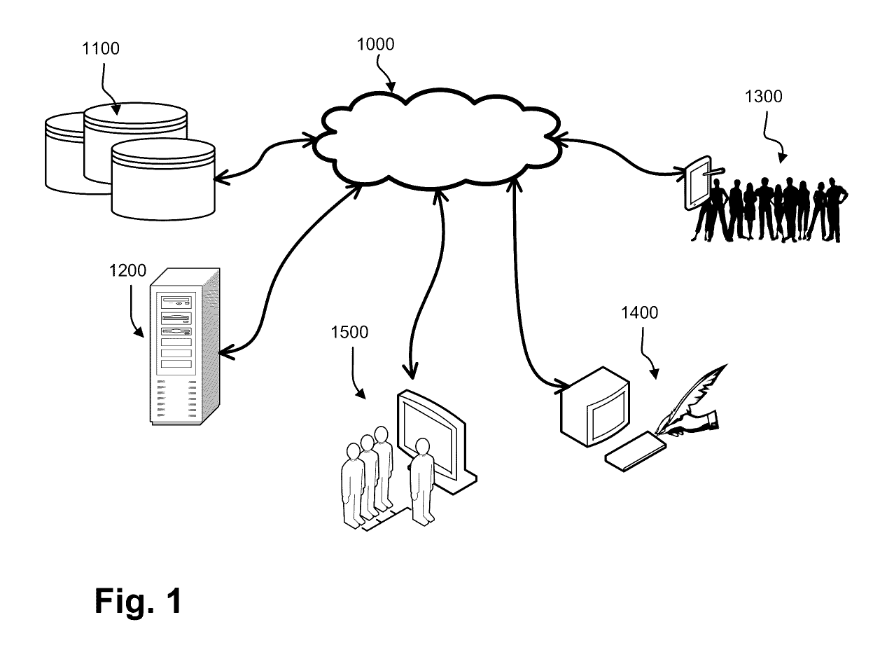

FIG. 1 is a diagram of a computing system utilizing the Internet in accordance with an exemplary embodiment of the invention. In this embodiment the system is interconnected by the Internet (1000) which hosts one or more databases (1100) accessed by one or more servers (1200). Content creators (1400), often writers, create projects which are uploaded to the servers (1200) and stored in the databases (1100). General Users (1300), also known as voters, view projects and vote or otherwise show their support for the projects. Production (1500) comprising producers and/or studios utilize the support for projects to determine potential success of projects.

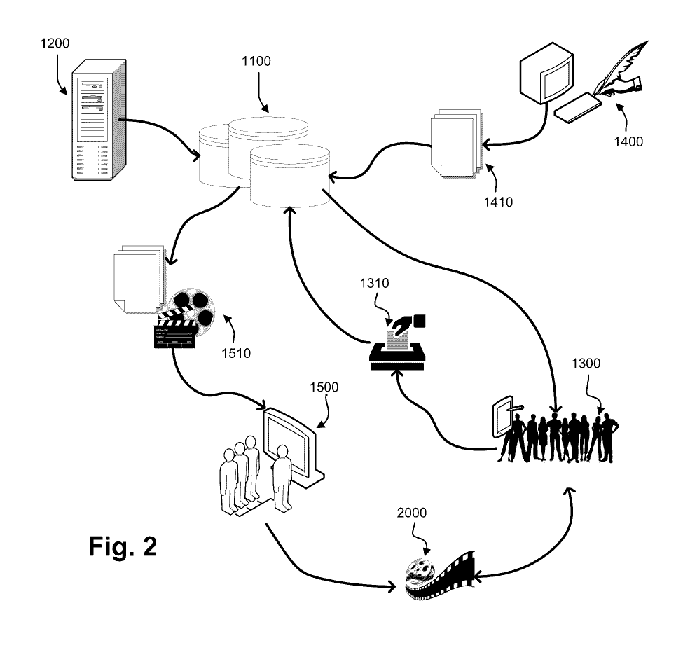

FIG. 2 illustrates the relationship of user actions of a computing system in accordance with an exemplary embodiment of the invention. A content creator (1400) enters creative content (1410) into the system database (1100) maintained by the system servers (1200). General users (1300) review the creative content (1410) in various formats and cast votes of support (1310) which are recorded and weighted by the system. The creative content (1410) along with voting support (1310) and other endorsements (not represented) develop into a project (1510), which is selected by production (1500) and developed into an entertainment product (2000).

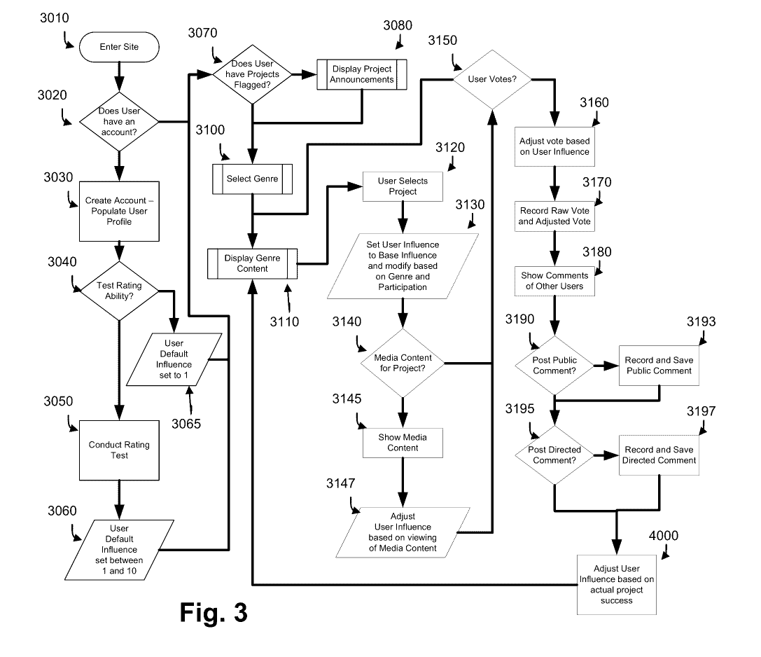

FIG. 3 is a flowchart illustrating exemplary interactions of a voting user in accordance with an exemplary embodiment of the invention. In this embodiment, an Internet website hosts and controls actions according to a program. The user enters the site (3010) by logging into an account or creating a new account. If the user does not have an account (3020), then a new account is created (3030) and user profile information is collected. This information may include, but is not limited to: name, address, preferred genre, occupation, income levels. The user has an option to test their rating ability (3040) which will give the user a boosted influence rating by taking a ratings test (3050) described further below. Based on the results of the ratings test (3050), a user's default influence is set within a prescribed range (3060). In the event the user decides not to take the rating test (3040) to boost their influence rating, then the user's default influence is set to the lowest value (3065).

When a user has been identified/authenticated, the system will greet them and identify any projects the user has selected as being “of interest.” If there are projects of interest (3070) which have updates, then those project announcements are shown to the user (3080). This keeps the user “in the know” on projects they support. Users can continuously select new projects/creative content for review. To narrow the possibilities, a user may classify projects and sort them. One popular method is to classify projects based on genre.

Once a user selects a classification (3100), they will be presented a list of projects within that classification (3110). The user selects a project (3120) to review. The user's influence is adjusted (3130) for the particular project based on the user influence weighting factors explained below. If there is media content (3140), then the user may select the content for viewing/listening/playing (3145). Taking the time to view the project thoroughly affects a user's opinion and their support is weighted accordingly (3147). If the user does not choose to cast a vote (3150), they are returned to the projects list to begin review of another project. If the user rates the project by voting (3150), then the “raw vote” cast is adjusted based on the user's influence (3160). Both the raw vote and the adjusted vote are recorded by the system (3170).

After voting, a user is able to view comments by other users (3180). It is important that this information is not available until after voting has occurred so the user's own opinion, and not the “popular opinion” is acquired by the system. A user is then given the opportunity to post comments which are visible to other voters (3190 and 3193). The user is also given the opportunity to post directed comments (3195 and 3197). Directed comments are directed to particular entities involved in the project such as the writer, director, talent, etc.

Each vote by a user is participation in the system, and a small investment into the entertainment industry. A user's voting is particularly important when their voting is historically shown to be aligned with later successes of the projects. Therefore, project successes are rated and correlated with user voting for the project. Project success may be classified based on opening revenue, total ticket sales, awards garnered, or other industry standard and/or proprietary methods of calculation.

One embodiment of conducting the rating test (3050) is to select a series of projects which have already been produced into entertainment products, and released to the public. Utilizing early pre-production screen plays, concept graphics, and a summary which describes, but does not reveal the actual final project, then see how the user rates the project through voting. Better results can be obtained by not utilizing “blockbuster movies”, but rather selecting less successful films or lower grossing films and determine if ratings align with the average or lower actual success, or possible lack thereof. In one embodiment there could be different tests based on the genres of interest identified by the user. In the preferred embodiment there is a larger selection of projects, by an order of magnitude, than that presented to a single user. The projects presented in a single rating test may be randomized, or may be adaptive based on prior answers.

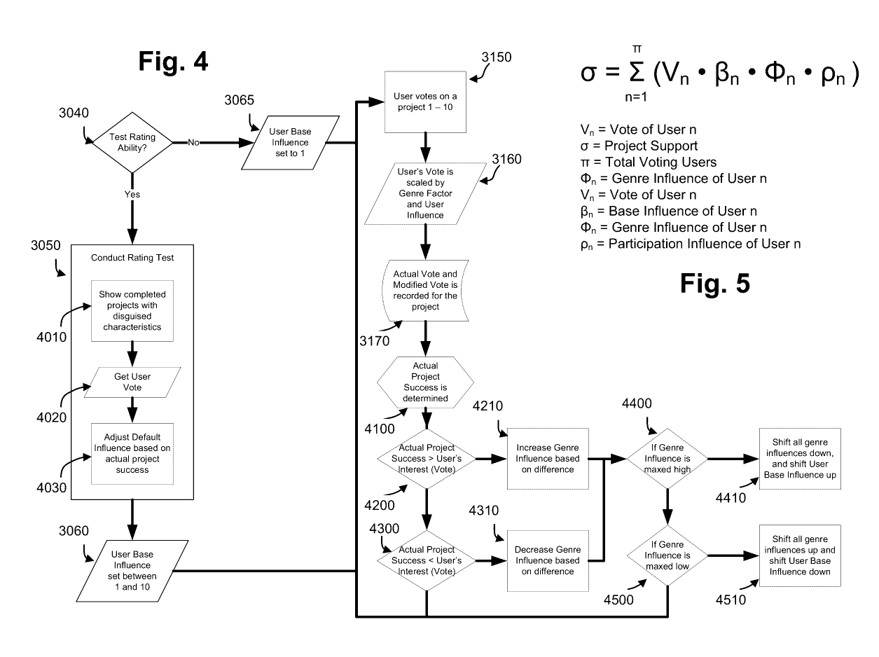

FIG. 4 is a flowchart illustrating calculation and adjustment of influence of a voting user in accordance with an exemplary embodiment of the invention. A new user has an option to select to participate in a ratings test to test rating ability (3040). If the user selects to participate, then a ratings test is administered (3050). The ratings test comprises the review of a series of completed projects with disguised characteristics (4010). The user will vote on the projects (4020). These votes are compared to the actual success of the projects to determine the user's default influence rating (4030). In one embodiment a rating is calculated by adjusting a mid-level rating up or down, depending on the difference between the actual success and the voter rating of each project. In one embodiment a user's default influence rating is calculated as a sum of the averages between the actual success and the user rating.

If the user decides not to take a test of rating ability (3040), then the user's base influence is set to the lowest value (3065) so the user's actual influence is mitigated until their accuracy is shown through actual voting. Since this can take time due to the delay between user voting and acquiring actual project success data, it is in the user's best interest to take a rating ability test. Once a User's base influence is established, it can be adjusted by user voting on actual projects (3150). User's ability to predict success may not be universal across all areas, so scaling can be applied according to classifications of the project. In the preferred embodiment a user's vote is scaled by a Genre Factor as well as by the User's Influence (3160). Both the actual vote and the modified vote are recorded for the project (3170). Both may be utilized for various purposes, including but not limited to: display to the user, calculation of user influence, calculation of project support, statistical data for administrators and third parties.

Once a project is produced and an Entertainment Industry product is created, the success of the project can be determined (4100). If the actual project's success is greater than the user's ratings (4200), then the scaling factor of the classification is increased based on the difference (4210). If the actual project's success is less than the user's ratings (4300), then the scaling factor of the classification is decreased based on the difference (4310).

If the scaling factor of the classification is at or near its maximum setting based on an increase (4400), then all scaling factors of all classifications are shifted down, and the base user influence is shifted up (4410). If the scaling factor of the classification is at or near its minimum setting based on a decrease (4500), then all scaling factors of all classifications are shifted up, and the base user influence is shifted down (4510). In the rare instance where a user has a classification factor at or near its maximum and a different classification factor at or near its minimum, then the result will be that the scaling factor in the most recently used of the two will be corrected, and the other will be shifted outside of its normal range, and the deviation from the normal range will not be caught in the normal process. However, routine administration of the database system should identify such deviations in a user's data. These deviations indicate a user with excessive ability to predict industry trends, either by being in sync, or completely out of sync with industry trends.

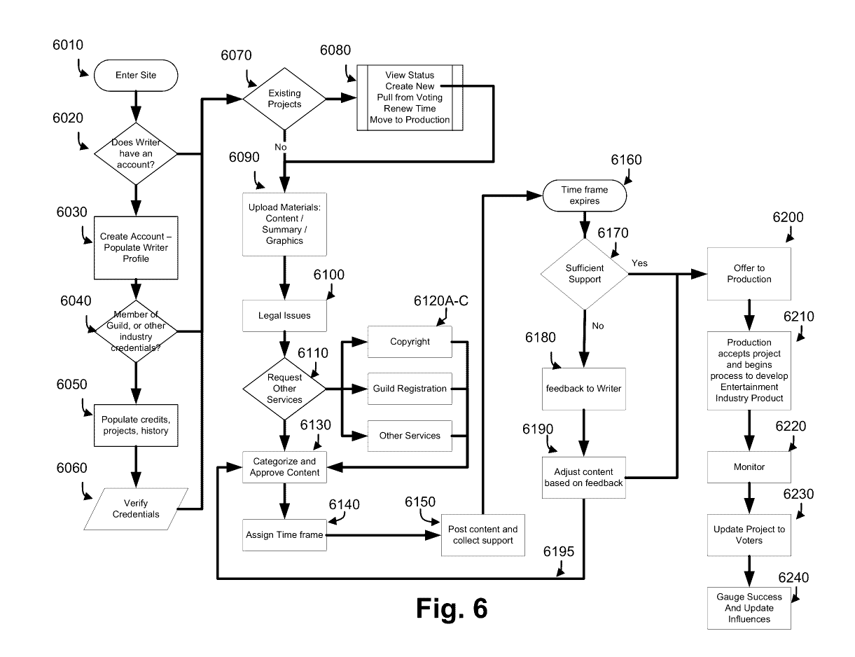

FIG. 5 shows the equation for determining Project Support by considering the influence level of voting users in accordance with an exemplary embodiment of the invention. Project Support (σ) is equal to the Summation of the total voting user population (π) of the product of the Vote of each user (Vₙ), the Base Influence of each user (βₙ) the Genre Influence of each user (Φn), and the Participation Influence of each user (ρₙ).

FIG. 6 is a flowchart illustrating exemplary interactions of a content creator (a Writer) in accordance with an exemplary embodiment of the invention. In this embodiment, an Internet website hosts and controls actions according to a program. The writer enters the site (6010) by logging into an account or creating a new account. If the writer does not have an account (6020), then a new account is created (6030) and writer profile information is collected. This information may include, but is not limited to: name, address, schooling, agent contact info.

The Writer then has to indicate if they are a professional writer (6040). The Writer enters their registration in the Writers Guild, publication credits, or any other industry credentials (6050) which will give the Writer a boosted credibility as a professional writer and verify their identity. The credentials entered are verified by administrative staff of the site, or other third-party (6060) to verify identity.

When a Writer has been identified/authenticated, the system will greet them and identify any projects the Writer has registered in the system (6070). The Writer may then manage their existing projects or create new ones (6080). If the user does not have existing projects, then the first step is to create one. Creating a project begins by uploading the creative content (6090) which may include, but is not limited to: the descriptive creative content, a summary, sample graphics, descriptions, storyboards. The Writer needs to certify that they are the rightful owner, or representative of the owner of the creative content, and have the rights to share, post, or otherwise make representations regarding the content (6100). Additionally, there may be other legal matters which are not pertinent to this patent.

In the preferred embodiment, a Writer may then request additional services such as filing a copyright on the creative content (6120A), registering the work with a Writer's Guild (6120B), or other services (6120C) which can be done by representatives of the site's administrative staff on behalf of the Writer. Next, content must be categorized and approved by site administration. This ensures content is: of at least a minimal quality, is not highly offensive to the general public (or is at least tagged as potentially offensive materials), and properly categorized in a standardized fashion. Site administration conducting the classification procedures ensures uniformity and predictability.

Once information has been classified, approved, formatted, and otherwise prepared for site presentation, it is then assigned a time frame in which it will be exposed to the voting users (6140). Then content is posted and allowed to collect support of the users (6150) in accordance with procedures described elsewhere in this application. After the time frame expires (6160), the support level of the project is determined (6170). If there is insufficient support, the feedback to the Writer (6180) allows them to remove the project from the process to avoid wasted resources, or the Writer may incorporate feedback (6190) to adjust the project into a different offering which may gain more support when reoffered (6195).

If the project has sufficient support (6170), then it is offered to production (6200). Sufficient support can be determined by numerous methods. In one embodiment, sufficient support is defined as the Writer's own determination of how much support he determines is necessary to predict success for the particular project. In another embodiment, sufficient support is defined by Production's own determination of how much support they determine is necessary to predict success for a particular project. Sufficient support may be defined for a sequel or otherwise related project as being at least as high as that acquired for the previous project. Site administration may determine (based on past performance of similar projects, market analysis, industry experience, or other factors), a level of support at which they may then attempt to market the project to one or more Production entities.

Once a production accepts a project, they begin the process to develop an entertainment industry project (6210). During the development, the site continues to monitor the project's development (6220). Updates on the development are reported back to the voters (6230) to continue generating and renewing interest in the project so that the product is successful. The system continues to work as a pre-marketing for the project. It also further enhances the “in the know” status of the voters and early supports as incentive to continue supporting and participating in the system.

Spiffs can be awarded during the process to voters to continue garnering interest and additional support. This makes a project and the future entertainment industry product relevant current news, and extends the marketing cycle without staleness developing for the project. The continued interest can be gauged through the system by determining how long a user spends viewing the project's updates, and if they participate in other activities related to the project. As an example, a casting director may reveal to the voting audience that two talents are being considered for a particular role, and the audience may vote or comment in support of their preferred talent. As another example, clothing or prop decisions could be made by voter audience feedback through the site. These activities give the voting audience a sense of ownership and commitment to a project which ultimately translates into larger success for the entertainment industry product. Eventually the product is released and success is measured, and the influence ratings of the voting users is updated based on their ability, through initial voting, to predict the success of the product resulting from the original project.

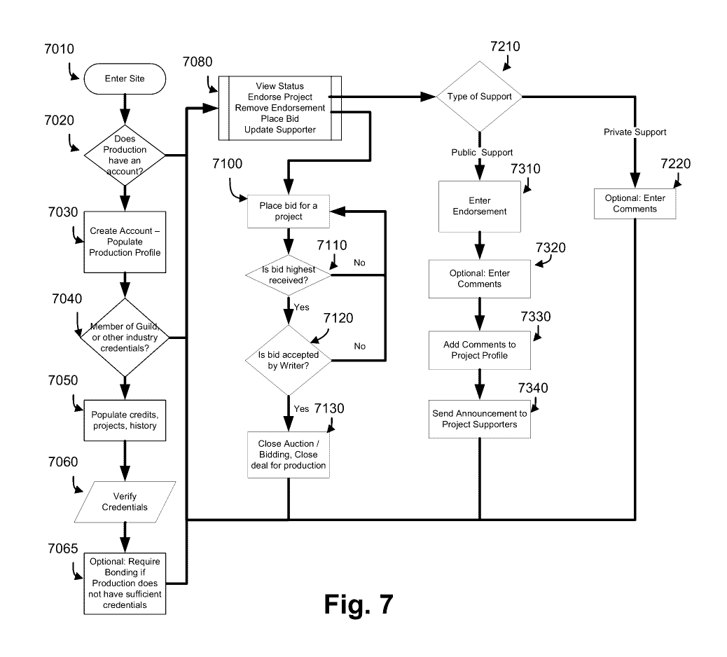

FIG. 7 is a flowchart illustrating exemplary interactions of a production user (Production) in accordance with an exemplary embodiment of the invention. In this embodiment, an Internet website hosts and controls actions according to a program. The production user (Production) enters the site (7010) by logging into an account or creating a new account. If Production does not have an account (7020), then a new account is created (7030) and production profile information is collected. This information may include, but is not limited to: name, address, contact info, areas of interest, funding levels, desired project types.

Production then indicates associations and registrations with the entertainment industry (7040). Production enters their registration in the Writers Guild, publication credits, or any other industry credentials (7050) which will give Production a boosted credibility as a legitimate production company and verifies their identity. The credentials entered are verified by administrative staff of the site, or other third-party (7060) to ensure correct identity and avoid spoofing. If Production is not established, or does not have sufficient industry credentials to confirm legitimacy, they may be required to post bond (7065) as backing to their entry into bidding or other financial transactions through the system.

When production has been identified/authenticated, the system will greet them and allow them to manage their existing projects or identify new ones of interest (7080). Production may view status of projects. Unlike Writers who can only view their own projects, or voters who cannot see ratings on projects they are not supporting, Production's view of projects allows them to see current support ratings for projects. This support may show varying levels of detail, depending on the time frame of a project, the level of Production's account, or other factors controlled by site administration.

Production may endorse a project (7080, 2^{nd} option). The type of endorsement may be public or private (7210). Public endorsement (7310) is visible to the voting users and the Writer. It shows support for a project by a studio, director, etc. In addition to just associating the name of Production with the project (7310), Production may enter comments for the Writer (7320) stating how and why the project is being endorsed. An optional comment may be entered for public viewing (7330) to further enhance the endorsement, or to qualify the endorsement, or promote the project and encourage additional support. Supporters of the project receive a special announcement of the Production support (7340). Other voting users will see Production's support as part of their normal process of viewing a project.

Production may place a bid on a project (7100). In the preferred embodiment, bids are private matters between Production and the Writer with site administration possibly overseeing and brokering an agreement or representing the Writer. If a bid is not the highest received, or if an active auction is in progress, then a bid may be rejected or held until withdrawn. Production is given notice of lower bids or rejected bids (7110) so they may reoffer. Once a bid is accepted by the Writer (7120), the deal for production is closed, and a project moves to pre-production status (7130).

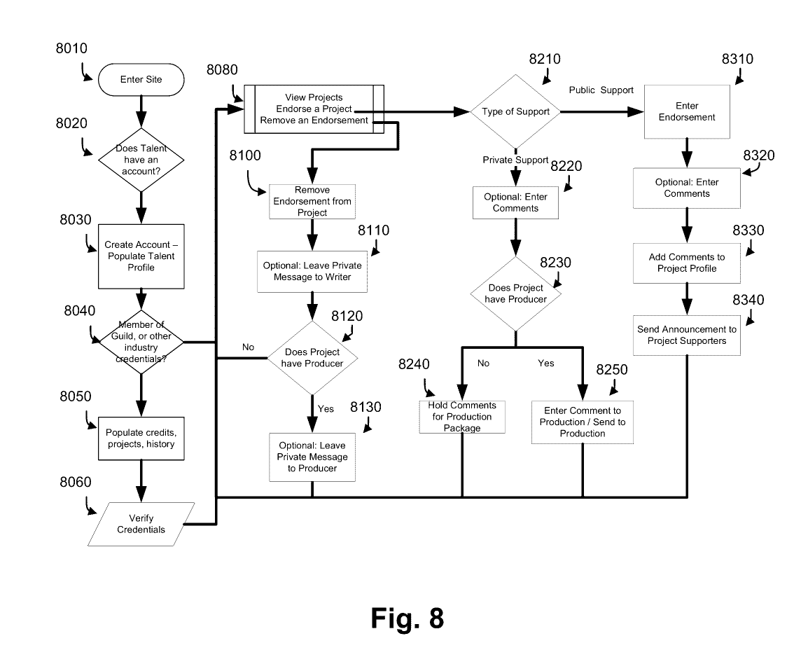

FIG. 8 is a flowchart illustrating exemplary interactions of a talent user (Talent) in accordance with an exemplary embodiment of the invention. In this embodiment, an Internet website hosts and controls actions according to a program. The actor/actress, artist, director, etc. (Talent) enters the site (8010) by logging into an account or creating a new account. If Talent does not have an account (8020), then a new account is created (8030) and talent profile information is collected. This information may include, but is not limited to: name, address, agent information, occupation, headshots, portfolio, areas of interest, desired project types.

Talent then indicates associations and registrations with the entertainment industry (8040). Talent enters their registration in the Actor's Guild, publication credits, or any other industry credentials (8050) which will give Talent a boosted credibility as legitimate Talent and verifies their identity. The credentials entered are verified by administrative staff of the site, or other third-party (8060) to ensure correct identity and avoid spoofing.

When Talent has been identified/authenticated, the system will greet them and allow them to manage their existing projects or identify new ones of interest (8080). Talent may view status of projects. Unlike Writers who can only view their own projects, or voters who cannot see ratings on projects they are not supporting, Talent's view of projects may allow them to see current support ratings for projects. This support may show varying levels of detail depending on the time frame of a project, the level of Talent's account, or other factors controlled by site administration.

Talent may endorse a project (8080, 2^{nd} option). The type of endorsement may be public or private (8210). Public endorsement (8310) is visible to the voting users and the Writer. It shows support for a project by the Talent and their willingness to appear in or contribute to a project during production (and possibly pre-production, depending on the Talent's position). In addition to just associating the name of Talent with the project (8310), Talent may enter comments for the Writer (8320) stating how and why the project is being endorsed. An optional comment may be entered for public viewing (8330) to further enhance the endorsement, or to qualify the endorsement, or promote the project and encourage additional support. Supporters of the project receive a special announcement of the Talent support (8340). Other voting users will see Talent's support as part of their normal process of viewing a project.

Private endorsement is not visible to the voting users. Talent is given the opportunity to enter comments associated with the endorsement (8220). The comments are visible to the Writers, and depending on if the project has an associated Producer (8230, yes option), the Talent's comments may be supplemented and sent to Production (8250). If the project does not have an associated producer (8230, no option), then the Talent's comments are held as part of a Production Package (8240) which is sent to prospective production when a project goes to bid.

Talent may wish to withdraw an endorsement (8080, 3^{rd} option). The endorsement is removed from a project (8100). In the preferred embodiment, removing an endorsement is a private matter between Talent and the Writer or Production. Writers and Production then have other means of announcing the actions and spinning it to their supporters (i.e. Talent may not make an announcement to supporters on their own without Writers' and/or Production's approval.) Talent is given the opportunity to leave a private message to the Writer (8110) possibly giving a reason for removing the support. If the project currently has Production (8120), then the Talent is given the opportunity to leave a private message to the Production (8130).

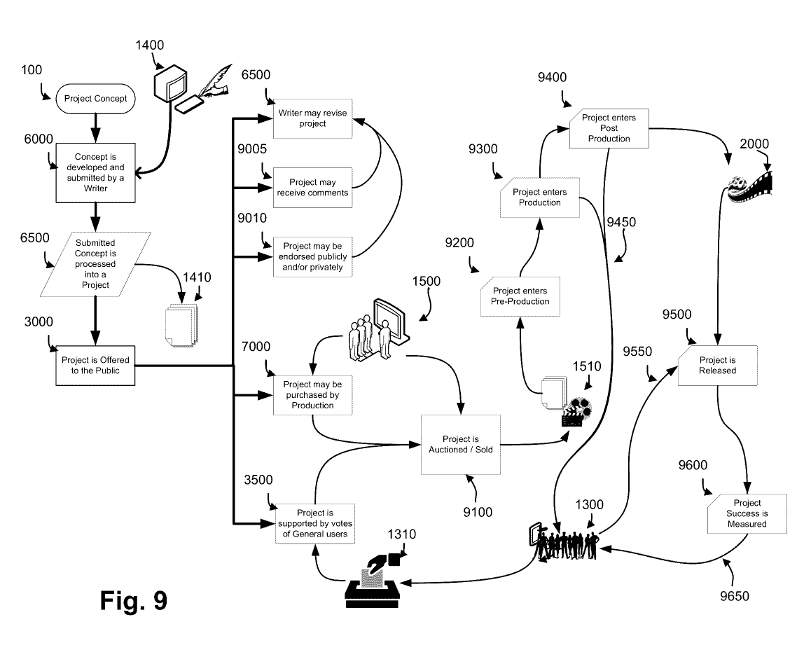

FIG. 9 illustrates the actions of a project from initial concept to final release and public acceptance in accordance with an exemplary embodiment of the invention. A project concept (100) is conceived by a content creator/Writer (1400). The concept is developed and submitted by a Writer (6000). The submitted concept is processed (6500) into a project (1410). The project (1410) is offered to the public (3000) for viewing/voting/rating/commenting. The project may receive comments from the public, talent, and/or production (9005). The project may receive endorsement from talent and/or production, which may be public or private (9010). The comments and/or endorsements may be incorporated into project revisions by the Writer (6500).

A project may be purchased (7000) by Production (1500) based on early interest, comments, or support through the system. The project may garner support (3500) by voting users (1300) who review the content and cast votes of support (1310). When sufficient support is achieved, the project may be auctioned (9100) between multiple Productions (1500). Once Production has purchased the project and begun developing it into an entertainment industry project (1510) the project will enter what the industry commonly calls pre-production (9200). It will then progress through production (9300) and post production (9400). During which time the project is monitored and reported (9450) to the voting user (1300).

Note that monitoring and reporting is done in conjunction with the Production and is meant to support and extend the normal marketing efforts of Production. It is ultimately controlled by Production to ensure it does not reveal plots, endings, or otherwise affect the movie viewing experience. Production's production process ends with the development of an entertainment industry product (2000) which is released to the public (9500) through traditional means. The voting users (1300), along with the general public, view or consume the project (9550) through traditional means. The product's success is measured through traditional industry means. The product (2000)'s success is not the same as the Project's (1410) success, but there is a strong correlation. Project's success is measured (9600) and used as feedback (9650) to adjust the influences of the voting users (1300).

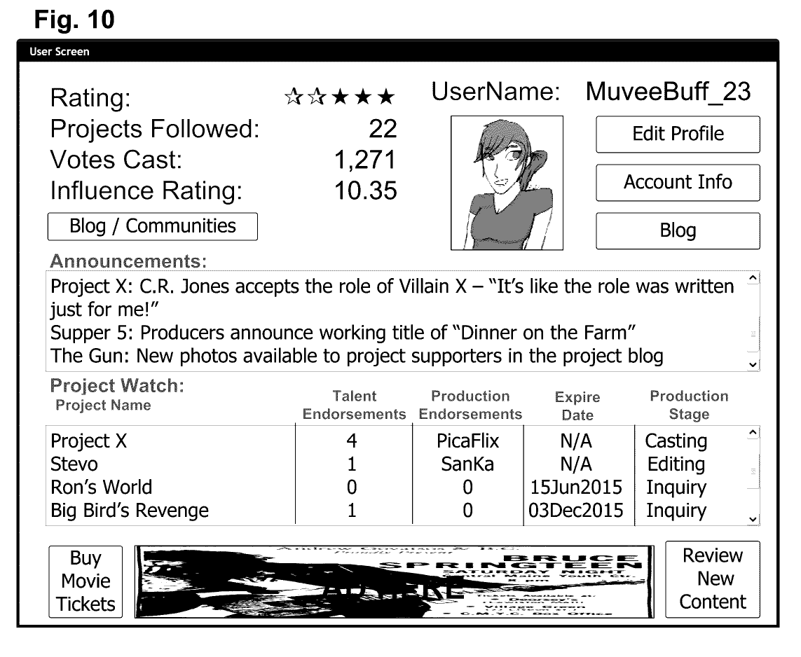

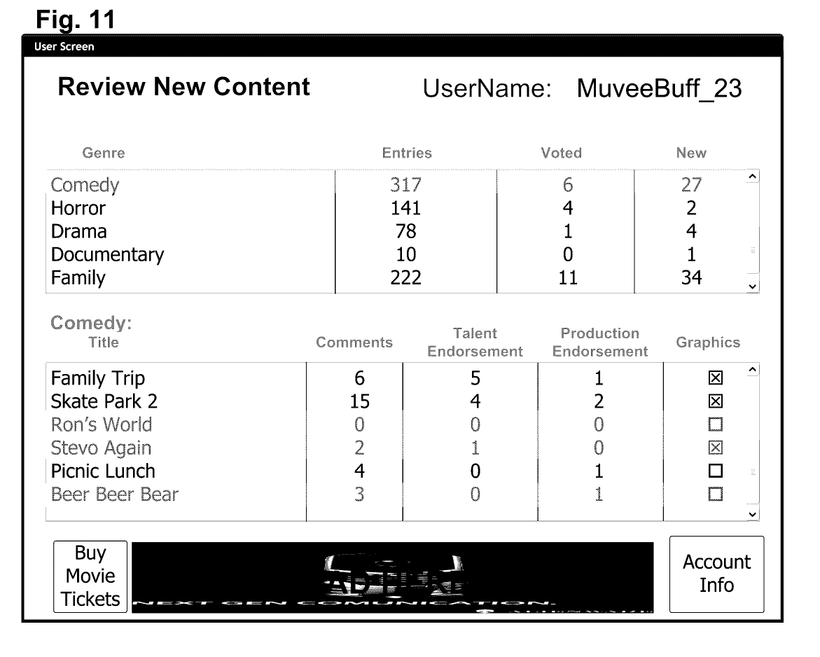

FIG. 10 is an exemplary home screen layout of a voting user in accordance with an exemplary embodiment of the invention. The home screen shows the username in the upper right corner along with an avatar or photo of the user which may be utilized on blogs. Additionally, the upper right corner contains methods for the user to modify their profile, adjust or monitor their account, or access their personal blog for commentary and community interaction.

The upper left corner contains system statistics for the user such as the current rating, the number of projects being followed, number of votes cast, and the influence rating. The rating is calculated by factoring: opinions of other voters (through blogging), opinions of writers, talent, production (through comments to projects), and site activity. The influence rating, described elsewhere is a factor of successful prediction of future project success as proven through system rating activity.

The middle of the screen contains an announcements section which lists news and announcements for projects a user is following. It is a conglomeration of the latest activity on all projects listed in chronological order. In one embodiment the announcements may only be active for a limited amount of time based on relevance. In another embodiment the announcements may remain in a cue until they have been displayed to the user, then automatically be removed from the system. In another embodiment the announcements may remain in a cue until the user specifically removes them or acknowledges them. In another embodiment the announcements viewed may be determined by user settings, such as a relevancy category, or a time frame set by the user. (i.e. show any announcement less than 2 weeks old; show only announcements which are regarding casting changes; or show only announcements with photos.)

Below the announcements is a project watch window. This lists relevant data for any project which the user is supporting and has added to their watch list as a project of interest to them. All projects would be visible until a user cancels their interest, or the project is removed from the system. Each listing would give a user a link to view a project page which has a collection of all project information to keep the user “in the know” about the project. In the preferred embodiment, the bottom of the screen is reserved for third-party targeted advertisements, banner ads, etc. It also includes a link to review new content, which a user can utilize to view new projects in the system for which they have not cast votes.

FIG. 11 is an exemplary project review screen layout in accordance with an exemplary embodiment of the invention. When a user selects the option to review new content, they are taken to the review new content screen which contains a listing of classifications and total projects in each classification along with a breakdown of which projects the user has viewed/voted/tracked, and new projects. By selecting a classification, illustrated herein as the comedy genre, a list of projects in the classification appear in the lower window. Limited information allows the user to determine if they have sufficient interest to investigate the project further. In this embodiment projects which have already been reviewed are marked with shading so new projects can be quickly identified. The bottom of the screen in the preferred embodiment is reserved for targeted third-party advertising and other information the user may desire to access.

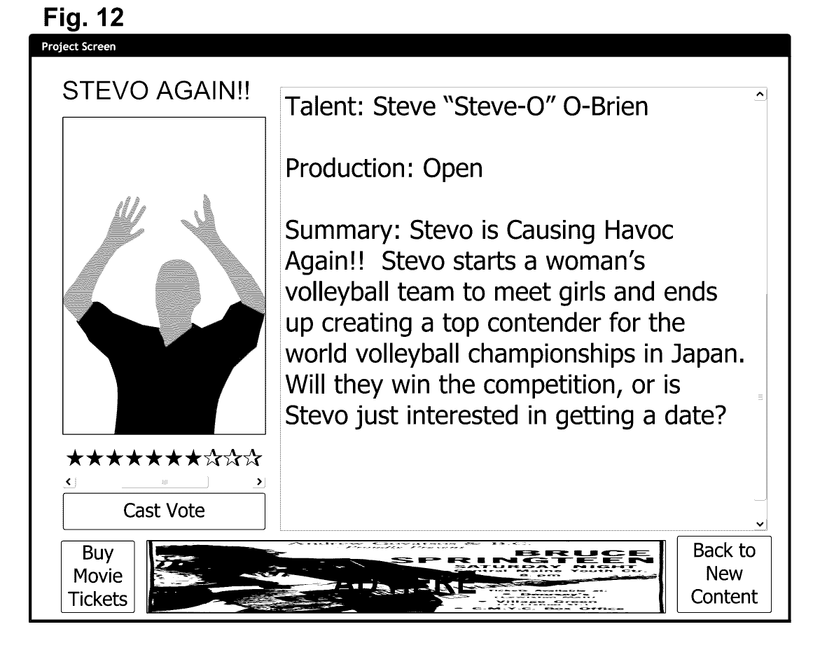

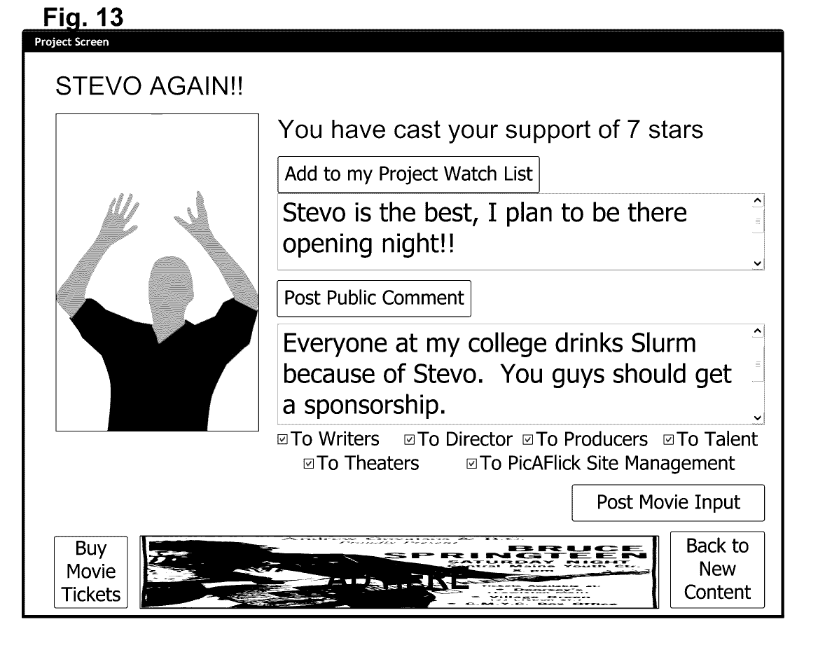

FIG. 12 is an exemplary project view screen layout in accordance with an exemplary embodiment of the invention. In this embodiment the project title is displayed in the upper left corner above the project graphics. This graphic may be a still picture, a collage of a plurality of pictures which can be zoomed, a slide show, or players for other multi-media content. The window to the right displays project information such as talent endorsement, production endorsements, and summary information. Under the multi-media window is a sliding scale where the user can select their rating and cast their vote.

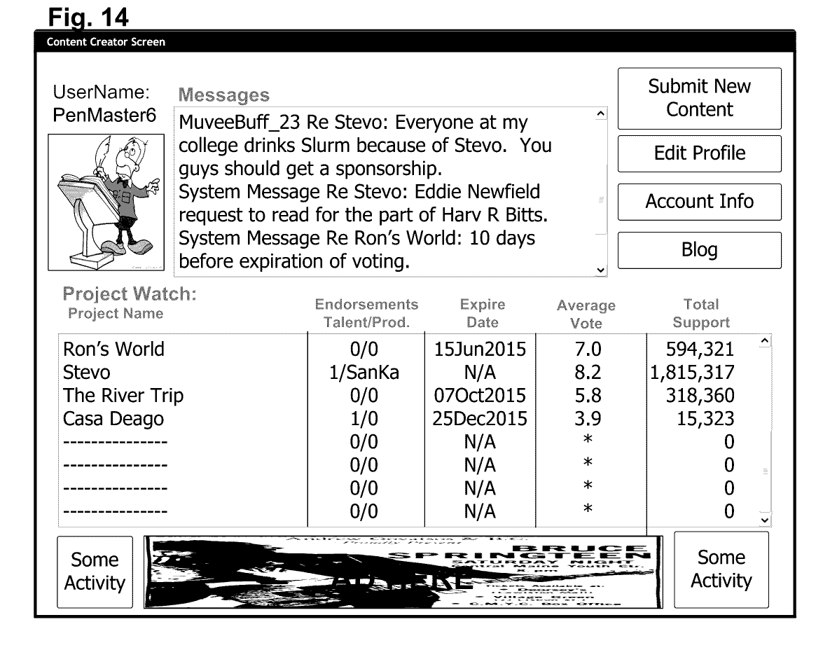

FIG. 13 is an exemplary project voting and commenting screen in accordance with an exemplary embodiment of the invention. Once the user has cast their vote, they are given the opportunity to target the project for tracking They are also given the opportunity to post comments to other voters (public comments) or to enter targeted private comments and select the comment's targeted audience. In the preferred embodiment a single private comment can be entered, but it may be targeted to multiple places. In another embodiment multiple comments may be entered and targeted individually.

FIG. 14 is an exemplary home screen layout of a content creator in accordance with an exemplary embodiment of the invention. In this embodiment a username is displayed in the upper left corner and the user's avatar is displayed underneath. Since users may have multiple roles in the system such as Content Creator and Voting User, moving this information to a different location helps the user remember the role they are currently portraying. The messages window is a running list of messages from the writer's projects, these messages will remain in the system as long as the related project is in the system. The latest messages will be added to the top of the list with the list scrolled down to put the oldest unread message in the middle of the window. Buttons on the right allow the writer to perform a variety of activities associated with their account. The project watch window in the middle of the screen shows the writer's current projects and a quick view of the project's current support. Clicking on the project bring the writer to the writer's project window where they can review messages or activity related to a specific project.

The flow diagrams in accordance with exemplary embodiments of the present invention are provided as examples and should not be construed to limit other embodiments within the scope of the invention. For instance, the blocks should not be construed as steps that must proceed in a particular order. Additional blocks/steps may be added, some blocks/steps removed, or the order of the blocks/steps altered and still be within the scope of the invention. Further, blocks within different figures can be added to or exchanged with other blocks in other figures. Further yet, specific numerical data values (such as specific quantities, numbers, categories, etc.) or other specific information should be interpreted as illustrative for discussing exemplary embodiments. Such specific information is not provided to limit the invention.

The diagrams in accordance with exemplary embodiments of the present invention are provided as examples and should not be construed to limit other embodiments within the scope of the invention. For instance, heights, widths, and thicknesses may not be to scale and should not be construed to limit the invention to the particular proportions illustrated. Additionally, some elements illustrated in the singularity may actually be implemented in a plurality. Further, some element illustrated in the plurality could actually vary in count. Further, some elements illustrated in one form could actually vary in detail. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory (such as memory of the handheld portable electronic device) and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of selecting production content for entertainment projects comprising;
soliciting content submissions for entertainment projects from content creators;
displaying characteristics of content for review by voters;
receiving and recording votes by voters to determine support; and
predicting success of entertainment projects by the support of voters.

2. A method, as described in claim 1, wherein concept submissions comprises one or more of: television series concepts, teleplays, episode scripts, series bibles, movie story concept, television story concept, music, video game design, player character profile, and/or game map.

3. A method, as described in claim 1, wherein displaying characteristics of content is formularized and automated to minimize bias of presenter.

4. A method, as described in claim 1, wherein support is determined by voters' indications of likelihood of watching, attending, listening, or otherwise consuming a final entertainment project based on the displayed content.

5. A method, as described in claim 4, wherein support is determined on content prior to the start of production of the entertainment project.

6. A method, as described in claim 1, further comprising collecting credentials of the content creator and verifying their identity.

7. A method, as described in claim 1, further comprising sorting and rating content prior to displaying it for review.

8. A method, as described in claim 1, further comprising weighting votes of voters based on prior voting history.

9. A method, as described in claim 1, further comprising weighting votes of voters based on results of testing of a voter's acumen at predicting project successes.

10. A method, as described in claim 1, further comprising weighting votes of voters based on voter participation and engagement in other projects.

11. A method, as described in claim 8, wherein prior voting history is identified on a per-category basis.

12. A method, as described in claim 1, further comprising:
providing voters additional incentives during production of project to maintain and/or increase support for the project.

13. A method, as described in claim 12, further comprising:
automatically updating voters with additional information regarding content they have supported.

14. A method, as described in claim 12, wherein additional incentives comprises one or more of the following:
early release information on production;
discounts on project branded merchandise;
discount admission to project events;
inclusion in closed project events.

15. A method, as described in claim 1, further comprising:
displaying characteristics of content for review by talent;
receiving and recording support and/or comments by talent to show support and potential involvement in projects based on content.

16. A method, as described in claim 15, further comprising:
reporting talent support and/or comment to voters as a characteristic of content.

17. A method, as described in claim 15, wherein talent comprises one or more of the following:
actors, directors, make-up artist, special effects specialist, writers, production specialist.

18. A method, as described in claim 1, wherein support levels for content are not shown to voters until a voter has cast their own vote.

19. A method, as described in claim 1, wherein writers may review and revise content based on support and comments received.

20. A method, as described in claim 19, wherein voters of original content are notified of revised content and given opportunity to re-cast prior votes, or change votes based on revised content.
